(19) United States
(12) Patent Application Publication
(10) Pub. No.: US 2008/0247109 A1
(43) Pub. Date: Oct. 9, 2008

(54) ELECTRIC OUTLET FOR COMPUTER AND RELATED COMPUTER PERIPHERALS

(75) Inventors: XIAO-ZHU CHEN, Shenzhen (CN); KE SUN, Shenzhen (CN); ZHEN-XING YE, Shenzhen (CN); MING-KE CHEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/778,094

(22) Filed: Jul. 16, 2007

(30) Foreign Application Priority Data
Apr. 4, 2007 (CN) 200710200394.5

(51) Int. Cl. H02H 3/24

(52) U.S. Cl. 361/92

(57) ABSTRACT

An exemplary electric outlet includes a power cable having a live wire and a naught wire; a first socket connected to the power cable; and at least one second socket connected to the power cable via an electric switch. The electric switch turn off the at least one second socket when a power of the first socket drops below its threshold value.

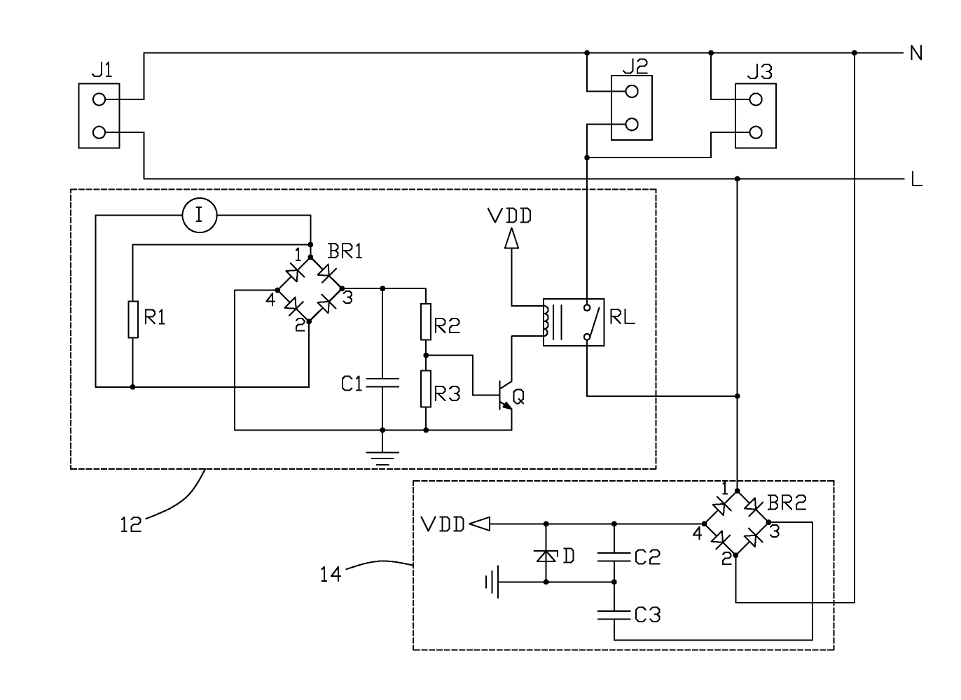

### BACKGROUND OF THE INVENTION

1. Field of the Invention

The present invention relates to electric outlets, and particularly to an electric outlet for providing power to a computer and related computer peripherals.

2. Description of Related Art

A variety of electric outlets have been disclosed for use to provide power. In order to provide power to a computer system and related computer peripherals such as monitors, printers, modems, speakers, scanners, digital camera and etc., multiple sockets may be necessary. When a multiple-socket electric outlet is used for a computer system and the related computer peripherals, it is necessary to manually turn off each computer peripheral when the computer system is in a “Stand By” state, if one wants to save electricity.

What is needed, therefore, is an electric outlet which can solve the above problem.

### SUMMARY OF THE INVENTION

An exemplary electric outlet includes a power cable having a live wire and a naught wire; a first socket having two terminals connected to corresponding wires of the power cable; and at least one second socket having two terminals connected to corresponding wires of the power cable via a control circuit, wherein the control circuit detects an output power of the first electric socked unit and turns off the at least one second socket when the output power of the first electric socked unit drops below a threshold value thereof.

The control circuit comprises a sampling circuit for sampling voltage of the first electric outlet; a first rectification circuit having two input terminals connected to two terminals of the sampling circuit respectively for receiving the voltage sample, and two output terminals connected to each other via a resister to provide a rectified voltage; an electric switch having a first terminal connected to an end of the resister, a second terminal connected to another end of the resister, and a third terminal, the electric switch being turned on when the rectified voltage rises above a turn-on threshold value of the electric switch; and a relay-switch with two relay leads and two switch leads, one of the relay leads being connected to a power source, another one of the relay leads being connected to the third terminal of the electric switch, one of the switch leads being connected to a live wire of the power cable, and another one of the switch leads being connected to the corresponding terminal of the at least one second socket.

Other advantages and novel features will become more apparent from the following detailed description when taken in conjunction with the accompanying drawing, in which:

### BRIEF DESCRIPTION OF THE DRAWINGS

The drawing is a circuit diagram of one embodiment of an electric outlet in accordance with the present invention.

### DETAILED DESCRIPTION OF THE INVENTION

Referring to the drawing, an electric outlet in accordance with a preferred embodiment of the present invention includes three sockets J1˜J3, a control circuit 12, and a power cable having a live wire (or hot line) L and a naught wire (or neutral line) N. The socket J1 has two terminals respectively connected to corresponding wires L and N of the power cable. The sockets J2˜J3 each has two terminals wherein one terminal is connected to the naught wire N and the other terminal is connected to the live wire L via the control circuit 12.

The control circuit 12 includes a sampling circuit, a first rectification circuit BR1, a transistor Q functioning as an electric switch, and a relay-switch RL. The sampling circuit includes an AC current inductor I connected in parallel with a resistor R1. The sampling circuit samples the output power of the socket J1. The circuit BR1 has two input terminals 1˜2 connected to opposite ends of the resistor R1 for receiving the voltage sample, and two output terminals 3˜4 to provide a rectified voltage. Two resisters R2 and R3 connected in series are connected in parallel with a capacitor C1 between the output terminals 3˜4 of the circuit BR1. A base of the transistor Q is connected to a node between the resisters R2 and R3. An emitter of the transistor Q is connected to the output terminal 4 of the circuit BR1 and ground. The transistor Q is turned on when the rectified voltage rises above a turnover threshold value thereof. The relay-switch RL has two relay leads and two switch leads, wherein one of the relay leads is connected to a power source VDD, the other one of the relay leads is connected to a collector of the transistor Q, one of the switch leads is connected to the other terminal of the sockets J2˜J3, and the other one of the switch leads is connected to the live wire L of the power cable. It should be noted that in other embodiments, other types of electric switches may be used for the transistor Q.

The control circuit 12 detects an output power of the socket J1, and turns on the sockets J2˜J3 when the output power of the socket J1 rise above a threshold value or turn off the sockets J2˜J3 when the output power of the first socket J1 drops below the threshold value.

The electric outlet further includes a voltage transformation circuit 14. The voltage transformation circuit 14 includes a second rectification circuit BR2 and a constant voltage control circuit. The circuit BR2 has two input terminals 1˜2 connected to corresponding wires L and N of the power cable, and two output terminals 3˜4 for providing a DC power. The constant voltage control circuit is connected to the output terminals 3˜4 of the circuit BR2 to receive the DC power and generate the power source VDD. The constant voltage control circuit includes two capacitors C3 and C2 connected in series between the output terminals 3˜4 of the circuit BR2, and a zener diode D has an anode connected to a node between the capacitors C3 and C2 and ground, and a cathode connected to the output terminal 4 of the circuit BR2 to provide the power source VDD such as 12V or 4V.

The socket J1 is a three-phase socket for a computer. The sockets J2˜J3 can be either three-phase sockets or two-phase sockets for related computer peripherals.

In this exemplary embodiment, the turnover threshold value of the transistor Q is 0.3V, the resistance of the resistor R2 is equal to the resistance of the resistor R3, the resistance of the resistor R1 is 530 Ohms, voltage drop of the circuit BR1 is 0.3V, the AC current inductor I has 200 loops. The threshold value of the output power of the electric outlet J1 is 30 watts. The induced electric current of the AC current inductor I is 0.001364 A when the output power of the socket J1 is 30 watts and an output voltage of the socket J1 is 110V. The sampling voltage on the resistor R1 is about 0.724V, and rectified voltage output of the circuit BR1 is 0.6V. Therefore, the voltage on the resistor R3 is 0.3V.

When the output power of the socket J1 rises above 30 watts, the voltage on the resistor R3 is greater than 0.3V for turning on the switch Q to turn on the relay-switch RL. Therefore, the sockets J2˜J3 are turned on. When the output power of the socket J1 is 30 watts or less, the voltage on the resistor R3 is not enough to turn on the switch Q. Therefore, the sockets J2˜J3 are turned off.

Additionally, the resister R1 as disclosed above is a rheostat that can be adjusted to provide some other voltages according to the turnover threshold value of the electric switch.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electric outlet comprising:
a power cable having a live wire and a naught wire;
a first socket having two terminals respectively connected to corresponding wires of the power cable; and
at least one second socket having two terminals one connected to the naught wire and the other one connected to the live wire of the power cable via a control circuit, wherein the control circuit detects an output power of the first socket and turns off the at least one second socket when the output power of the first socket drops below a threshold value, the control circuit comprises:
a sampling circuit for sampling the output power of the first electric outlet to generate a voltage sample;
a first rectification circuit having two input terminals connected to two terminals of the sampling circuit respectively for receiving the voltage sample, and two output terminals connected to each other via a first resister to provide a rectified voltage;
an electric switch having a first terminal connected to an end of the first resister, a second terminal connected to another end of the first resister, and a third terminal, the electric switch being turned on when the rectified voltage rises above a turnover threshold value of the electric switch; and
a relay-switch with two relay leads and two switch leads, one of the relay leads being connected to a power source, the other one of the relay leads being connected to the third terminal of the electric switch, one of the switch leads being connected to the live wire of the power cable, and the other one of the switch leads being connected to the other one of the terminals of the at least one second socket.

2. The electric outlet as claimed in claim 1, wherein the electric switch is an NPN transistor.

3. The electric outlet as claimed in claim 1, wherein the threshold value of the output power of the first socket is 30 watts.

4. The electric outlet as claimed in claim 1, wherein the sampling circuit includes an AC current inductor in parallel with a second resistor connected between the two input terminals of the first rectification circuit.

5. The electric outlet as claimed in claim 4, wherein the second resistor is a rheostat.

6. The electric outlet as claimed in claim 1, wherein the power source is provided by a voltage transformation circuit which comprises:
a second rectification circuit having two input terminals connected to corresponding wires of the power cable, and two output terminals for providing DC power; and
a constant voltage control circuit connected to the output terminals of the second rectification circuit for receiving the DC power and providing the DC power to the one of the relay leads of the relay-switch.

7. The electric outlet as claimed in claim 6, wherein the constant voltage control circuit comprises:
two capacitors connected in series between the output terminals of the second rectification circuit; and
a zener diode having an anode connected to a node between the capacitors and ground, and a cathode connected to one of the output terminals of the second rectification circuit.

8. An electric outlet comprising:
a power cable having a live wire and a naught wire;
a first socket having two terminals connected to corresponding wires of the power cable respectively;
at least one second socket having two terminals connected to corresponding wires of the power cable via an electric switch which has a turnover threshold value;
a sampling circuit configured to generate a voltage sample based on an output power of the first electric socket; and
a first rectification circuit for receiving the voltage sample to provide a rectified voltage to the electric switch, so as to turn on or off the at least one second socket.

9. The electric outlet as claimed in claim 8, wherein the sampling circuit includes an AC current inductor connected in parallel with a resistor.

10. The electric outlet as claimed in claim 9, wherein the resistor is a rheostat.

11. The electric outlet as claimed in claim 8, wherein the electric switch is turned off when the output power of the first electric socket drops below a threshold value which results in the rectified voltage being less than the turnover threshold value of the electric switch.

12. An electric outlet comprising:
a power cable having a live wire and a naught wire;
a first socket having two terminals connected to the respective wires of the power cable; and
at least one second socket having two terminals one connected to the naught wire and the other one connected to the live wire via a relay-switch;
a sampling circuit configured to sample an output power of the first electric outlet to generate a corresponding voltage sample;
a first rectification circuit having two input terminals connected to two terminals of the sampling circuit respectively for receiving the voltage sample, and two output terminals connected to each other via a dividing circuit which has an output terminal to provide a divided rectified voltage;
an electric switch with a turnover threshold value, the electric switch having a control terminal connected to the output terminal of the dividing circuit, and an output terminal connected to the relay-switch for controlling conduction thereof, the electric switch being turned off to turn off the relay-switch when the output power of the first electric socket drops below a threshold value which results in the divided rectified voltage being less than the turnover threshold value of the electric switch.

13. The electric outlet as claimed in claim 12, wherein the threshold value of the output power of the first socket is 30 watts.

14. The electric outlet as claimed in claim 12, wherein the relay-switch has two relay leads and two switch leads, one of the relay leads being connected to a power source, the other one of the relay leads being connected to the output terminal of the electric switch, one of the switch leads being connected to the live wire of the power cable, and the other one of the switch leads being connected to the other one of the terminals of the at least one second socket.

15. The electric outlet as claimed in claim 14, wherein the power source is provided by a voltage transformation circuit which comprises a second rectification circuit having two input terminals connected to the respective wires of the power cable, and two output terminals for providing a DC power; and a constant voltage control circuit connected to the output terminals of the second rectification circuit for receiving the DC power and outputting the DC power to the relay-switch.

16. The electric outlet as claimed in claim 15, wherein the constant voltage control circuit comprises two capacitors connected in series between the output terminals of the second rectification circuit; and a zener diode having an anode connected to a node between the capacitors and ground, and a cathode connected to one of the output terminals of the second rectification circuit.
